(19) United States
(12) Patent Application Publication
(10) Pub. No.: US 2025/0297387 A1
(43) Pub. Date: Sep. 25, 2025

(54) CATALYST FOR HYDROGEN PRODUCTION

(71) Applicant: The University of Memphis Research Foundation, Memphis, TN (US)

(72) Inventors: Xuan Zhao, Memphis, TN (US); Ping Wang, Xiangtan (CN)

(73) Assignee: The University of Memphis Research Foundation, Memphis, TN (US)

(21) Appl. No.: 19/083,763

(22) Filed: Mar. 19, 2025

Related U.S. Application Data
(60) Provisional application No. 63/567,302, filed on Mar. 19, 2024.

(51) Int. Cl. C25B 11/085; C25B 1/04

(52) U.S. Cl. CPC C25B 11/085; C25B 1/04

(57) ABSTRACT

Provided herein are catalysts for producing hydrogen via the hydrogen evolution reaction (HER) during water splitting, methods of producing hydrogen via photocatalytic water splitting using the catalysts, and compositions for use in photocatalytic water splitting that include the catalysts. In some embodiments, a catalyst hereof is a metal complex of Formula I,

[M(L¹)(L²)][A] Formula I
wherein M is a transition metal, L¹ and L² are both ligands independently forming one or more coordinate bonds with the metal M, and A is an anion, and
wherein L¹ is a tetrapyridyl-amine (Py₄N) having four pyridyl groups and an amine group each forming a coordinate bond with the metal M.

### CROSS-REFERENCE TO RELATED APPLICATION

This application claims priority to U.S. Provisional Application No. 63/567,302, filed Mar. 19, 2024, entitled “CATALYST FOR HYDROGEN PRODUCTION,” the entire disclosure of which is hereby incorporated herein by reference.

### GOVERNMENT LICENSE RIGHTS

This invention was made with Government support under Contract Numbers 1352036, 2018806, and 2102265 awarded by the National Science Foundation, NSF. The Government has certain rights in this invention.

### BACKGROUND

Water splitting is a process used to produce hydrogen, H₂, from water with oxygen, O₂, as a byproduct. Water splitting is currently a focus in clean and sustainable energy efforts as it may provide the key to implementing widespread usage of hydrogen as an industrial energy source.

Water splitting generally involves decomposition of water into oxygen and hydrogen via two half-reactions: the oxygen evolution reaction (OER) and the hydrogen evolution reaction (HER). The OER involves the oxidation of water to oxygen. The HER involves the reduction of protons to hydrogen. The OER is thermodynamically more favorable at basic conditions, while the HER is thermodynamically preferred at low pHs.

A significant challenge to leveraging water splitting on a large scale are the reaction kinetics of the OER and the HER and, more particularly, the overpotentials for the OER and the HER that create kinetic energy barriers for driving water splitting. Catalysis is generally required to minimize the overpotentials for the OER and the HER. For example, the water splitting reactions may be driven by electrolysis using electric energy, thermolysis using thermal energy, or photolysis using sunlight or solar energy. Electrolysis and/or photolysis may be particularly advantageous water splitting techniques for producing clean hydrogen energy using clean and/or energy sources from electricity and/or sunlight.

Metal complexes based on cobalt, nickel, and iron have been developed for electro- and photocatalytic hydrogen production. The efficiency of electro- and photocatalysts for the HER is strongly pH-dependent. Only a very limited number metal complexes are known for catalyzing HER under basic conditions. The advantage of performing water splitting under basic conditions is that the OER is energetically much more challenging than the HER where, compared to HER which involves a two electron/two proton process, the OER involves a four electron/four proton process. Therefore, it would be thermodynamically advantageous to provide more efficient and effective catalysis of HER at basic conditions that are preferred for the OER when the water splitting is occurring in the same media from the coupling of the OER to the HER.

A shortcoming of metal complexes that have been reported for catalyzing the HER under basic conditions is that the conditions also include a presence of organic solvents. The highly oxidizing conditions needed for the OER suggest that organic solvents should be avoided for photocatalysis.

A need exists in the industry for catalysts that can drive the HER in basic or alkaline environments that include purely aqueous compositions in the absence of any organic solvent.

### SUMMARY

Embodiments of the present disclosure relate to catalysts for producing hydrogen via the hydrogen evolution reaction during water splitting. The catalysts advantageously have hydrogen evolution reaction activity in basic compositions that are thermodynamically favorable toward the oxygen evolution reaction via oxidation of water in the water splitting process. In this way, the catalysts hereof may facilitate the hydrogen evolution reaction and the oxygen evolution reaction occurring in mutually compatible compositions.

In one independent aspect, provided herein is a catalyst for producing hydrogen via the hydrogen evolution reaction during water splitting, wherein the catalyst is a metal complex of Formula I,

[M(L¹)(L²)][A] Formula I
wherein M is a transition metal, L¹ and L² are both ligands independently forming one or more coordinate bonds with the metal M, and A is an anion, and
wherein L¹ is a tetrapyridyl-amine (Py₄N) having four pyridyl groups and an amine group each forming a coordinate bond with the metal M.

In some aspects, the amine group of Py₄N is a tertiary amine group.
In some aspects, the tetrapyridyl-amine (Py₄N) has a Formula II,

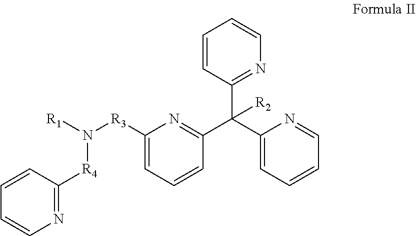

wherein R¹ and R² are each independently selected from the group consisting of hydrogen, alkyl, aryl, alkoxyl, and aryloxyl;
and R³ and R⁴ are each independently selected from the group consisting of alkyl, aryl, alkoxyl, and aryloxyl.

In some aspects, the tetrapyridyl-amine (Py₄N) has the Formula II and R¹, R², R³, and R⁴ are each independently selected from the group consisting of C₁-C₆ alkyl.

In some aspects, the tetrapyridyl-amine (Py₄N) has the Formula II, R¹, R², R³, and R⁴ are each a C₁ alkyl, and the ligand L¹ is of Formula IIa,

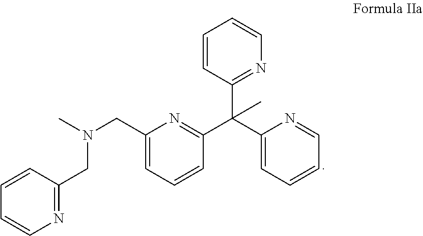 [SMILES: CN(Cc1ccccn1)Cc1cccc(C(C)(c2ccccn2)c2ccccn2)n1]

In some aspect, the catalyst is a metal complex of Formula Ia,

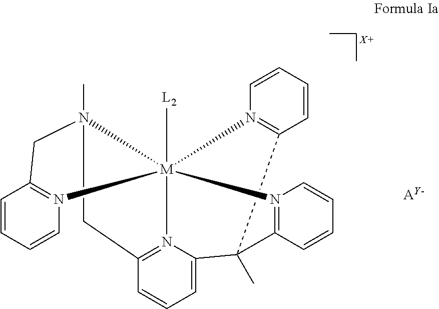

wherein X and Y are the same integer.

In some aspects, the catalyst is the metal complex of Formula Ia and X and Y are the same integer between 1 to 3.

In some aspects, the catalyst is the metal complex of Formula Ia and the metal M is cobalt.

In some aspects, the catalyst is a cobalt complex of Formula Ia-i,

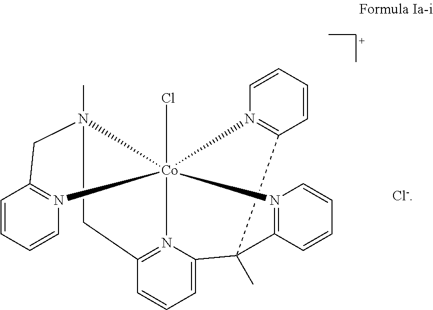

In some aspects, the catalyst is a cobalt complex of Formula Ia-ii,

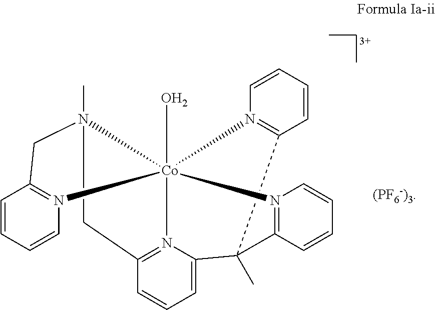

In another independent aspect, provided herein is a method of producing hydrogen via photocatalytic water splitting, the method comprising contacting an aqueous composition with a catalyst as described herein.

In some aspects, the catalyst has photolytic hydrogen evolution reaction activity in the aqueous composition to drive the hydrogen evolution reaction in response to light exposure.

In some aspects, the catalyst is a metal complex of Formula I as described herein. In some aspects, the ligand L¹ is a tetrapyridyl-amine (Py₄N), such as the tetrapyridyl-amine of Formula II.

In some aspects, the catalyst is a cobalt complex of Formula I as described herein, wherein the ligand L¹ is a tetrapyridyl-amine (Py₄N), such as the tetrapyridyl-amine of Formula II, and the metal M is cobalt, such as Co(II) or Co(III).

In some aspects, the catalyst is a metal complex of Formula Ia as described herein.

In some aspects, the catalyst is a cobalt complex of Formula Ia as described herein, wherein the metal M is cobalt, such as Co(II) or Co(III).

In some aspects, the catalyst is a cobalt complex of Formula Ia-I as described herein, a cobalt complex of Formula Ia-ii as described herein, or a combination thereof.

In some aspects, the aqueous composition is configured such that the oxygen evolution reaction in the aqueous composition is thermodynamically favored in response to the light exposure over the hydrogen evolution reaction in the absence of the catalyst in the aqueous composition.

In some aspects, the aqueous composition is an aqueous alkaline composition having a pH of greater than 8.

In some aspects, the aqueous composition is an aqueous alkaline composition comprising the water as a primary solvent.

In some aspects, the aqueous alkaline composition is substantially free of organic solvents and/or non-aqueous solvents.

In some aspects, the method further comprises exposing the catalyst to light via a light source to drive the hydrogen evolution reaction. In some aspects, the light source comprises sunlight, one or more UV lamps, one or more Xenon lamps, or a combination thereof.

In another independent aspect, provided herein is a composition for use in photocatalytic water splitting. The composition comprises water and a catalyst as described herein.

In some aspects, the catalyst has photolytic hydrogen evolution reaction activity in the aqueous composition to drive the hydrogen evolution reaction in response to light exposure.

In some aspects, the catalyst is a metal complex of Formula I as described herein. In some aspects, the ligand L¹ is a tetrapyridyl-amine (Py₄N), such as the tetrapyridyl-amine of Formula II.

In some aspects, the catalyst is a cobalt complex of Formula I as described herein, wherein the ligand L¹ is a tetrapyridyl-amine (Py₄N), such as the tetrapyridyl-amine of Formula II, and the metal M is cobalt, such as Co(II) or Co(III).

In some aspects, the catalyst is a metal complex of Formula Ia as described herein.

In some aspects, the catalyst is a cobalt complex of Formula Ia as described herein, wherein the metal M is cobalt, such as Co(II) or Co(III).

In some aspects, the catalyst is a cobalt complex of Formula Ia-I as described herein, a cobalt complex of Formula Ia-ii as described herein, or a combination thereof.

In some aspects, the composition is configured such that the oxygen evolution reaction in the composition is thermodynamically favored in response to light exposure over the hydrogen evolution reaction in the absence of the catalyst in the composition.

In some aspects, the composition is an aqueous alkaline composition comprising the water as a primary solvent, wherein the aqueous alkaline composition is substantially free of organic solvents and/or non-aqueous solvents.

Objects, features, and advantages will become in part apparent and in part pointed out when reading the present disclosure in its entirety.

### DETAILED DESCRIPTION

Provided herein are catalysts having photolytic hydrogen evolution reaction (HER) activity. The HER is a key reaction in water splitting for producing hydrogen as an alternative energy source. The ability to produce hydrogen using photocatalysis may provide an optimal solution to environmental and energy conservation as it allows the production of a clean energy source, hydrogen, from a renewable energy source, light. In this way, the catalysts hereof may address the shortcomings of current solar-driven water splitting processes and may provide economic, eco-friendly, and sustainable pathways toward widespread use of hydrogen energy on an industrial scale.

Advantageously, the catalysts provided herein can catalyze photolytic HER in an alkaline or basic environment. In this way, the catalysts can be used in environments that are thermodynamically favorable toward the OER via oxidation of water in the water splitting process. The catalysts hereof may thereby facilitate the HER and the OER occurring in mutually compatible compositions. Moreover, in embodiments, the catalysts may function in aqueous environments that may be substantially free of organic solvent and/or non-aqueous solvents. In embodiments, the catalysts may be functional in aqueous environments having a pH of greater than 8, such as a pH between 8 to 10, or a pH of about 9.

In some embodiments, the catalysts include molecular metal complexes such as cobalt complexes. Without being bound by a particular theory, density functional theory calculation suggests that the metal complexes may facilitate a modified electron transfer (E)—proton transfer (C)—electron transfer (E)—proton transfer (C) (mod-ECEC) pathway for hydrogen production from the protonation of Metal cation—H species. For example, cobalt complexes may provide the mod-ECEC pathway for hydrogen production from the protonation of Co(II)—H species.

Surprisingly, molecular metal complexes hereof have high photocatalytic HER activity in basic aqueous compositions and significantly outperform other catalysts in neutral and basic compositions. Certain molecular metal complexes are demonstrated herein to drive photocatalytic HERs in purely aqueous compositions with a turnover number (TON) of 218,000 and a turnover frequency (TOF) of 12500/hour over the course of several hours (e.g., five hours). The remarkable photocatalytic activity of the catalysts hereof may result from subtle structural change of the ligand scaffold in the metal complex. This may signal the importance of structure-function relationships in the molecular catalyst design and provides a pathway to further development of the photocatalytic HER in alkaline or basic environments. The present disclosure thereby significantly advances the development of molecular metal catalyst for solar- or light-driven HER in more challenging alkaline aqueous compositions that may facilitate significant advances in solar-driven water-splitting systems.

### Terms and Definitions

Terms used in this description have the following meanings unless expressly stated otherwise or the context clearly indicates otherwise.

The “HER” means the hydrogen evolution reaction, or half reaction, that is involved in water splitting to generate hydrogen, H₂, via reduction of protons.

The “OER” means the oxygen evolution reaction, or half reaction, that is involved in water splitting to generate oxygen, O₂, via oxidation of water.

Co(I), Co^{I}, and Co^{I+} refer to the +1 cation of Cobalt (Co). Co(I), Co^{I}, and Co^{I+} may be used interchangeably.

Co(II), Co^{II}, and Co²⁺ refer to the +2 cation of Cobalt (Co). Co(II), Co^{II}, and Co²⁺ may be used interchangeably.

Co(III), Co^{III}, and Co³⁺ refer to the +3 cation of Cobalt (Co). Co(III), Co^{III}, and Co³⁺ may be used interchangeably.

“Py” used in the context of chemical compounds means pyridine or a pyridyl (or pyridinyl) group.

“Bpy” used in the context of chemical compounds means bipyridine or a bipyridyl or bipyridinyl group, for example, 2,2′-bipyridine or a 2,2′-bipyridyl (or 2,2′-bipyridinyl) group. Unless expressly stated otherwise, the presence of at two pyridyl or Py groups in a chemical compound does not imply that the chemical compound could include a bipyridyl or Bpy group.

“DPA” used in the context of chemical compounds means dipicolyl amine.

“Me” used in the context of chemical compounds means methane or a methyl group.

Chemical elements are identified using their ordinary element symbols.

“DPA-Bpy” used in the context of chemical compounds means N,N-bis(2-pyridinyl-methyl)-2,2′-bipyridine-6-methanamine.

“Py₃Me-Bpy” used in the context of chemical compounds means 6-[6-(1,1-di-pyridin-2-yl-ethyl)-pyridin-2-ylmethyl]-[2,2′]bipyridinyl.

“Py₄NMe” used in the context of chemical compounds means 1-(6-(1,1-di(pyridin-2-yl)ethyl)pyridin-2-yl)-N-methyl-N-(pyridin-2-ylmethyl)methanamine.

“Alkyl” used in the context of chemical compounds refers to a straight or branched chain moiety comprising up to 10 carbon atoms. Non-limiting examples of suitable alkyl groups include methyl, ethyl, propyl, butyl, pentyl, and hexyl. The alkyl group may be a straight-chain alkyl group or a branched alkyl group (e.g., isopropyl). In some embodiments, the alkyl group is optionally independently substituted with one or more substituents (e.g., methyl, ethyl, methoxyl, carboxyl, etc.).

“Aryl” used in the context of chemical compounds refers to an aromatic moiety comprising from 6 to 14 carbon atoms. The aryl group may be optionally independently substituted with one or more substituents (e.g., methyl, ethyl, methoxyl, carboxyl, etc.). Non-limiting examples of suitable aryl groups include phenyl, naphthyl, benzyl, tolyl, and xylyl.

“Alkoxyl” used in the context of chemical compounds refers to a group of the form —OR′, wherein R′ is alkyl as defined herein. For example, the group —OCH₃ may be referred to herein as “methoxyl.” The group —OCH₂CH₃ may be referred to herein as “ethoxyl.”

“Aryloxyl” used in the context of chemical compounds refers to a group of the form —OR′, wherein R′ is aryl as defined herein. For example, the group —O(C₆H₆) may be referred to herein as “phenoxyl.”

“Carboxyl” used in the context of chemical compounds refers to a group of the form —C(O)OH.

“Hydrogen” used in the context of chemical compounds includes both stable isotopes of hydrogen, namely ¹H (also known as protium) and ²H (also known as deuterium). “Hydrogen” used in the context of the product of the HER refers to H₂.

“TON” used in the context of catalytic properties means the catalyst turnover number.

“TOF” used in the context of catalytic properties means the catalyst turnover frequency.

“Aqueous” used in the context of compositions, solvents or solutions refers to compositions, solvents or solutions that include water as the primary solvent. Aqueous compositions, solutions or solvents of the present disclosure may be substantially free of organic solvents and/or non-aqueous solvents.

An “aqueous composition” or “aqueous solution” can include water as the sole component or optionally can include one or more components in addition to water.

“Metal complex,” “complex” and like terms mean a coordination compound formed by the union of one or more electronically rich molecules or atoms (e.g., one or more ligands) with one or more electronically poor molecules or atoms such as a metal (e.g., a transition metal). For example, a metal complex of this disclosure may include a central metal (e.g., a central transition metal) and one or more ligands having one or more pairs of unshared electrons (e.g., via donor atoms) for forming one or more coordinate covalent bonds or “coordinate bonds” with the central metal. The ultimate composition of the complex catalyst may also contain an additional ligand, for example, an anion satisfying the coordination sites or nuclear charge of the metal in the complex.

### EXAMPLE CATALYSTS

The embodiments of this disclosure relate to, inter alia, catalysts for the production of hydrogen via the HER of water splitting. Surprisingly, the catalysts hereof may have photolytic HER activity in a basic or high pH composition or solution, such as a composition or solution having a pH of greater than 8, a pH between 8 to 10, or a pH of about 9. In some embodiments, the catalysts hereof have photolytic HER activity in aqueous compositions or solutions, such as basic aqueous compositions or solutions. In some embodiments, the catalysts hereof have a TON of 218,000 in a basic composition or solution (e.g., a composition or solution having a pH of about 9), such as a basic aqueous composition or solution. In some embodiments, the catalysts hereof have a TOF of 12500/hour over the course of several hours (e.g., five hours) in a basic composition or solution (e.g., a composition or solution having a pH of about 9), such as a basic aqueous composition or solution.

In some embodiments, the catalyst comprises a metal catalyst. The metal catalyst may include a transition metal. In some embodiments, the metal catalyst comprises cobalt, nickel, or iron. In some embodiments, the metal catalyst comprises cobalt. The metal may be a metal ion, such as an ion of the metals described above. The metal catalyst may include a metal complex such as a transition metal complex. Preferably, the metal complex comprises a cobalt complex, a nickel complex, or an iron complex. More preferably, the metal catalyst comprises a cobalt complex.

In some embodiments, the metal catalyst comprises a metal complex of Formula I,

[M(L¹)(L²)]^{X+}[A]^{Y-} Formula I
wherein M is a metal, L¹ and L² are both ligands independently forming one or more coordinate bonds with the metal M, and A is an additional ligand or anion.

The metal M can include a transition metal as described above, such as cobalt, nickel, or iron. In preferred embodiments, the metal M comprises cobalt and the metal complex can be referred to as a cobalt complex.

For simplicity, [M(L¹)(L²)]^{X+} may be referred to as a cation and the additional ligand or anion A may be referred to as an anion. The anion A may satisfy remaining coordination sites of the metal M and/or a nuclear charge of the cation [M(L¹)(L²)]^{X+}. In some embodiments, the cation [M(L¹)(L²)]^{X+} has the positive charge X+ that is satisfied by a negative charge Y− of the anion A. X and Y are each integers. X and Y may be the same integer. In some embodiments, each of X and Y is an integer between 1 to 3. For example, each of X and Y may be 1, or each of X and Y may be 2, or each of X and Y may be 3. Formula I can also be written as [M(L¹)(L²)][A] when X and Y are the same integer.

The positive charge X+ may be defined by a nuclear charge of the metal M in the cation [M(L¹)(L²)]^{X+}. In particular, X+ designates the number of electrons needed to satisfy a primary valency or oxidation state of the metal M in the cation [M(L¹)(L²)]^{X+}. The metal M is referred to as a metal for simplicity but generally comprises a metal ion, such as an ion of the metals described above (e.g., a cobalt cation, a nickel cation, or an iron cation). The positive charge X+ may depend on both the primary valency or oxidation state of the metal M and the number of ligands L¹ and/or L² that contribute to satisfying the primary valency or oxidation state of the metal M. In some embodiments, one of the ligands L¹ or L² may contribute to satisfying the primary valency or oxidation state of the metal M. In some embodiments, none of the ligands L¹ or L² contribute to satisfying the primary valency or oxidation state of the metal M.

The primary valency or oxidation state of the metal M in Formula I may be an integer greater than or equal to 1. In some embodiments, the primary valency or oxidation state of the metal M may be between 1 to 3. Preferably, the primary valency or oxidation state of the metal M is 2 or 3. In preferred embodiments, the metal M is Co(II) or Co(III). Co(II) has a primary valency or oxidation state of +2. Co(III) has a primary valency or oxidation state of +3.

In some embodiments, the metal M is Co(III) and none of the ligands L¹ or L² contribute to satisfying its primary valency or oxidation state. In such embodiments, X is 3. In some embodiments, the metal M is Co(III) and one of the ligands L¹ or L² contributes to satisfying its primary valency or oxidation state. In such embodiments, X is 2. In some embodiments, the metal M is Co(II) and none of the ligands L¹ or L² contribute to satisfying its primary valency or oxidation state. In such embodiments, X is 2. In some embodiments, the metal M is Co(II) and one of the ligands L¹ or L² contributes to satisfying its primary valency or oxidation state. In such embodiments, X is 1.

In some embodiments, the anion A may vary depending on the positive charge X+. Non-limiting examples of the anion A include a halide ion (e.g., Cl⁻, Br⁻, I⁻, F⁻), (PF₆⁻)₂, (PF₆⁻)₃, and the like. In some embodiments, when X is 1, the anion A comprises a halide, preferably Cl⁻. In some embodiments, when X is 2, the anion A preferably comprises (PF₆⁻)₂. In some embodiments, when X is 3, the anion A preferably comprises (PF₆⁻)₃.

The ligands L¹ and L² include electronically rich molecules or atoms having one or more pairs of unshared electrons for forming one or more coordinate bonds with the metal M. The ligands L¹ and L² preferably satisfy the secondary valency or coordination number of the metal M. In some embodiments, the ligands L¹ and L² may also contribute to satisfying the primary valency as described above. Preferably, the ligands L¹ and L² entirely satisfy the secondary valency of the metal M. The anion A may only contribute to satisfying the primary valency of the metal M. In this regard, in some embodiments, the ligands L¹ and L² cooperatively form coordinate bonds with the metal M that are equal in number to the coordination number of the metal M. For example, the metal M may have a coordination number greater than 1, such as 2, 4, or 6.

In some embodiments, the metal M may have a coordination number of 6. For example, cobalt, iron, or nickel may each have a coordination number of 6. In these embodiments, the ligands L¹ and L² preferably cooperatively form six (6) coordinate bonds with the metal M. In certain embodiments, the ligand L¹ forms more coordinate bonds with the metal M than L². For example, where the coordination number of the metal M is 6, the ligand L¹ may form five (5) coordinate bonds with the metal M and the ligand L² may form one (1) coordinate bond with the metal M.

Preferably, the ligand L¹ may be a tetrapyridyl-amine (Py₄N) with four pyridyl groups and an amine group each forming a coordinate bond with the metal M. In some embodiments, none of the pyridyl groups of the ligand L¹ form a bipyridyl group. For example, in some embodiments, none of the pyridyl groups of the ligand L¹ form a 2,2′-bipyridyl group. In some embodiments, the amine group of the ligand L¹ may include a tertiary amine.

In preferred embodiments, the tetrapyridyl-amine has a Formula II

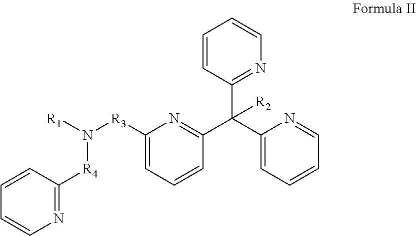

wherein R¹ and R² are each independently selected from the group consisting of hydrogen, alkyl, aryl, alkoxyl, and aryloxyl;
and R³ and R⁴ are each independently selected from the group consisting of alkyl, aryl, alkoxyl, and aryloxyl.

In some embodiments, R¹, R², R³, and R⁴ may each be independently selected from the group consisting of alkyl, aryl, alkoxyl, and aroxyl, each of which may be optionally independently substituted with one or more substituents selected from the group consisting of methyl, ethyl, methoxyl, and carboxyl. In some embodiments, R¹, R², R³, and R⁴ are each independently selected from the group consisting of C₁-C₆ alkyl.

In preferred embodiments, R¹, R², R³, and R⁴ are each a C₁ alkyl and the ligand L¹ is of Formula IIa,

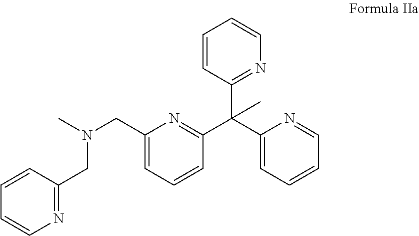 [SMILES: CN(Cc1ccccn1)Cc1cccc(C(C)(c2ccccn2)c2ccccn2)n1]

The ligand L¹ of Formula IIa may also be referred to as Py₄NMe or 1-(6-(1,1-di(pyridin-2-yl)ethyl)pyridin-2-yl)-N-methyl-N-(pyridin-2-ylmethyl)methanamine. Each nitrogen of the tetrapyridyl-amine ligand L¹ of Formula II may form a coordinate bond with the metal M of Formula I. For example, when the ligand L¹ is of Formula IIa, the metal complex is of Formula Ia,

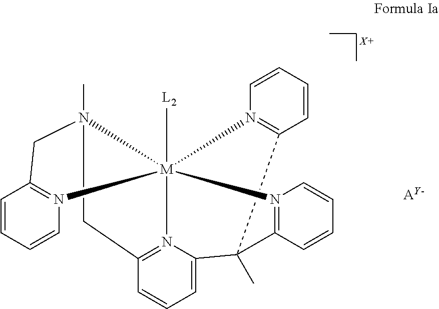

wherein M, L², A, X+, and Y− are as described above.

The metal complex of Formula Ia can also be referred to as [M(Py₄NMe)(L²)]^{X+}[A]^{Y-}.

In some embodiments, the metal M (e.g., cobalt) has a coordination number of 6. In these embodiments, five of the six coordination sites of the metal M may form a coordinate bond with a nitrogen of the tetrapyridyl-amine ligand L¹ of Formula II and the remaining coordination site of the metal M may form a coordinate bond with the ligand L². The ligand L² may include a molecule or atom with a pair of unshared electrons for forming the remaining coordinate bond with the metal M. Non-limiting examples of the ligand L² include a halide ion (e.g., Cl⁻, Br⁻, I⁻, F⁻) or a water molecule (OH₂).

In the metal complex of Formula Ia, the tetrapyridyl-amine ligand L¹ of Formula II does not contribute to satisfying the primary valency of the metal M. The positive charge X+ of the cation [M(Py₄NMe)(L²)]^{X+} may thereby be defined by the primary valency or oxidation state of the metal M and any ionic charge of the ligand L². In some embodiments, the ligand L² is not ionically charged (e.g., in the case where the ligand L² is a water molecule) and the positive charge X+ of the cation in Formula Ia is equal to the primary valency or oxidation state of the metal M. In some such embodiments, the metal M may include Co(II) and X is 2, or the metal M may include Co(III) and X is 3. In other embodiments, the ligand L² is ionically charged (e.g., in the case where the ligand L² is a halide such as Cl⁻) and the positive charge X+ of the cation in Formula Ia is equal to the primary valency or oxidation state of the metal M less the ionic charge of the ligand L² (e.g., −1). In some such embodiments where the ligand L² comprises a halide, the metal M may include Co(II) and X is 1, or the metal M may include Co(III) and X is 2.

As described above, the anion A may vary depending on the positive charge X+ of the cation in Formula Ia. For example, when X is 1, the anion A comprises a halide, preferably Cl⁻. In some embodiments, when X is 2, the anion A preferably comprises (PF₆⁻)₂. In some embodiments, when X is 3, the anion A preferably comprises (PF₆⁻)₃.

In one exemplary embodiment, the metal complex is a cobalt complex of Formula Ia-i,

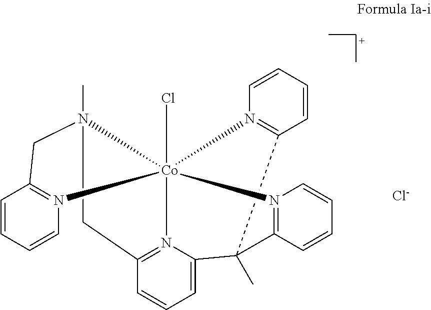

wherein the ligand L¹ is of Formula IIa, the metal M is Co(II), the ligand L² is a chloride ion, the anion A is a chloride ion, and X and Y are each 1.

The cobalt complex of Formula Ia-i may also be referred to as [Co(Py₄NMe)Cl][Cl].

In one exemplary embodiment, the metal complex is a cobalt complex of Formula Ia-ii,

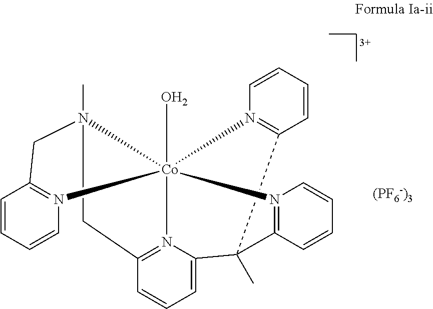

wherein the ligand L¹ is of Formula IIa, the metal M is Co(III), the ligand L² is a water molecule, the anion A is (PF₆⁻)₃, and X and Y are each 3.

The cobalt complex of Formula Ia-ii may also be referred to as [Co(Py₄NMe)(OH₂)][(PF₆)₃].

### Methods and Compositions for Producing Hydrogen Via Water Splitting

Also provided herein are methods of producing hydrogen via water splitting. An exemplary method comprises contacting a composition or solution comprising water with a catalyst hereof, wherein the catalyst has photolytic HER activity to drive the HER in response to light exposure. In some embodiments, contacting the composition or solution with the catalyst may include dispersing the catalyst in the composition or solution and the method may include exposing the composition or solution with the catalyst dispersed therein to light, whereby catalyst drives the HER in response to the light exposure. In some embodiments, the catalyst may be formed as a catalyst layer on a substrate of an electrode and contacting the composition or solution with the catalyst may include immersing the electrode having the catalyst layer formed thereon in the composition or solution. In these embodiments, the method may include exposing the electrode having the catalyst layer formed thereon to light. The photolytic water splitting reaction using the catalyst to drive the HER can be performed using any suitable photocatalytic water splitting technique known in the art.

In some embodiments of the method, the catalyst, and/or an electrode having the catalyst formed thereon, may be exposed to light to drive the HER in the composition or solution. Any suitable light source may be used, such as sunlight, UV lamps, Xenon lamps, or the like. As described herein, “exposing the catalyst to light” and like phrases encompasses direct exposure of the catalyst to light or photons as well as exposure of the catalyst to excited charge carriers (e.g., electrons) that are generated in response to light exposure. For example, the catalyst may be exposed to excited charge carriers (e.g., electrons) that are part of an electron-hole pair generated by a semiconducting material (e.g., titanium dioxide, TiO₂) in response to light exposure. In some embodiments, the catalyst may be formed as a catalyst layer on a substrate of an electrode and a further photocatalyst layer may be included on the electrode.

The catalyst used in the methods hereof may include any of the example catalysts described herein. In some embodiments of the method, the catalyst is a metal complex of Formula I wherein the ligand L¹ is a tetrapyridyl-amine (Py₄N), such as the tetrapyridyl-amine of Formula II. In some embodiments, the catalyst is a cobalt complex of Formula I, wherein the ligand L¹ is a tetrapyridyl-amine (Py₄N) (e.g., the tetrapyridyl-amine of Formula II) and the metal M is cobalt, such as Co(II) or Co(III). In some embodiments, the catalyst is a metal complex of Formula Ia as described herein. In some embodiments, the catalyst is a cobalt complex of Formula Ia, wherein the metal M is cobalt, such as Co(II) or Co(III). In some embodiments of the method, the catalyst is a cobalt complex of Formula Ia-i, a cobalt complex of Formula Ia-ii, or a combination thereof.

In some embodiments of the method, the composition or solution is configured such that the OER is thermodynamically favored in response to the light exposure over the HER in the absence of the catalyst. In some embodiments, the composition or solution is an alkaline composition or solution wherein the OER is thermodynamically favorable at basic conditions. For example, the alkaline composition or solution may have a pH greater than 8, such as a pH between 8 to 10, or a pH of about 9. In embodiments, the alkaline composition or solution comprises water and a base or hydroxide producer in the water. Non-limiting examples of the base include sodium hydroxide (NaOH), potassium hydroxide (KOH), calcium hydroxide (Ca(OH)₂), lithium hydroxide (LiOH), and combinations thereof. In some embodiments, the alkaline composition or solution comprises water, a base, and a pH buffer. Non-limiting examples of the pH buffer include boric acid (H₃BO₃), phosphoric acid (H₃PO₄), acetic acid (CH₃COOH), and combinations thereof. In some embodiments, the pH buffer may include a universal buffer, such as the Britton-Robinson buffer. In some embodiments, the alkaline composition or solution is an aqueous alkaline composition or solution and comprises water as the primary solvent. The alkaline composition or solution may be substantially free of organic solvents and/or non-aqueous solvents. For example, the alkaline composition or solution may include less than 25%, less than 20%, less than 15%, less than 10%, less than 5%, or less than 1% organic solvent and/or non-aqueous solvent.

Also provided herein is a composition or solution for use in photocatalytic water splitting. The composition or solution comprises water and a catalyst having photolytic HER activity in the composition or solution. The catalyst may include any of the example catalysts described herein. In some embodiments, the catalyst is a metal complex of Formula I wherein the ligand L¹ is a tetrapyridyl-amine (Py₄N), such as the tetrapyridyl-amine of Formula II. In some embodiments, the catalyst is a cobalt complex of Formula I, wherein the ligand L¹ is a tetrapyridyl-amine (Py₄N) (e.g., the tetrapyridyl-amine of Formula II) and the metal M is cobalt, such as Co(II) or Co(III). In some embodiments, the catalyst is a metal complex of Formula Ia as described herein. In some embodiments, the catalyst is a cobalt complex of Formula Ia, wherein the metal M is cobalt, such as Co(II) or Co(III). In some embodiments, the catalyst is a cobalt complex of Formula Ia-i, a cobalt complex of Formula Ia-ii, or a combination thereof. In some embodiments, the composition or solution is configured such that the OER is thermodynamically favored in response to the light exposure over the HER in the absence of the catalyst. In some embodiments, the composition or solution is an alkaline composition or solution wherein the OER is thermodynamically favorable at basic conditions. For example, the alkaline composition or solution may have a pH greater than 8, such as a pH between 8 to 10, or a pH of about 9. In embodiments, the alkaline composition or solution comprises water and a base or hydroxide producer in the water. Non-limiting examples of the base include sodium hydroxide (NaOH), potassium hydroxide (KOH), calcium hydroxide (Ca(OH)₂), lithium hydroxide (LiOH), and combinations thereof. In some embodiments, the alkaline composition or solution comprises water, a base, and a pH buffer. Non-limiting examples of the pH buffer include boric acid (H₃BO₃), phosphoric acid (H₃PO₄), acetic acid (CH₃COOH), and combinations thereof. In some embodiments, the pH buffer may include a universal buffer, such as the Britton-Robinson buffer. In some embodiments, the alkaline composition or solution is an aqueous alkaline composition or solution and comprises water as the primary solvent. The alkaline composition or solution may be substantially free of organic solvents and/or non-aqueous solvents. For example, the alkaline composition or solution may include less than 25%, less than 20%, less than 15%, less than 10%, less than 5%, or less than 1% organic solvent and/or non-aqueous solvent.

### EXAMPLES

The following non-limiting examples are provided to further illustrate the present disclosure. Reference is also made to the experimental procedures, results, analysis, and discussion provided in Ping Wang et al., “Photocatalytic Hydrogen Production with A Molecular Cobalt Complex in Alkaline Aqueous Solutions,” J. Am. Chem. Soc. 2024, 146, 14, 9493-9498 (Mar. 26, 2024), https://doi.org/10.1021/jacs.3c12928, and Supporting Information available at https://pubs.acs.org/doi/10.1021/jacs.3c12928?goto=supporting-info, the entire disclosure of which is hereby incorporated herein by reference.

### Example 1: Experimental Equipment and Materials

The compounds provided herein can be synthesized using techniques described herein and, to the extent not described herein, techniques that are known to those skilled in the art.

Representative examples of methods that may be used to synthesize particular compounds within the scope of the present disclosure are set forth below. Unless otherwise indicated, the equipment and materials described below were used in the following examples. All commercial chemicals were used without any purification. The UV/Vis absorption spectra of Co complexes were obtained from a GENESYS™ M 10S UV-Vis Spectrophotometer. ¹H NMR and 2D correlation spectroscopy (COSY) spectra were collected on a JEOL 400 MHz NMR spectrometer. JA values listed for NMR are the actual frequency differences and not the coupling constants. Electrospray ionization mass spectra (ESI-MS) were obtained from a Thermo Electron LCQ Advantage liquid chromatography-mass spectrometer. Elemental analyses were conducted by Atlantic Microlab, Inc., Atlanta, Georgia. The produced H₂ was quantitively measured by gas chromatography using an HP 5890 series II Gas Chromatograph with a TCD detector (Molecular sieves 5 Å column). Cyclic voltammetry (CV) experiments were done by using CH Instruments potentiostat (model 660A). Photocatalytic hydrogen production was conducted using techniques known in the art. Britton-Robinson buffers were prepared with 0.5 M of boric acid (H₃BO₃), phosphoric acid (H₃PO₄), acetic acid (CH₃COOH) and adjusted with NaOH to various pHs. Turnover numbers (TONs) for catalytic H₂ production by catalysts were calculated by subtracting the amount of H₂ produced in control experiments in the absence of catalyst under otherwise the same conditions. All experiments were conducted under an argon (Ar) atmosphere unless stated otherwise.

### Example 2: Synthesis of Compounds of Formula Ia-i and Formula Ia-ii

Scheme 1 below provides the synthetic scheme for the Py₄NMe ligand (Formula IIa) and the related Co complexes (Formula Ia-i and Formula Ia-ii). Description of each step of Scheme 1 to produce the related compounds is provided below.

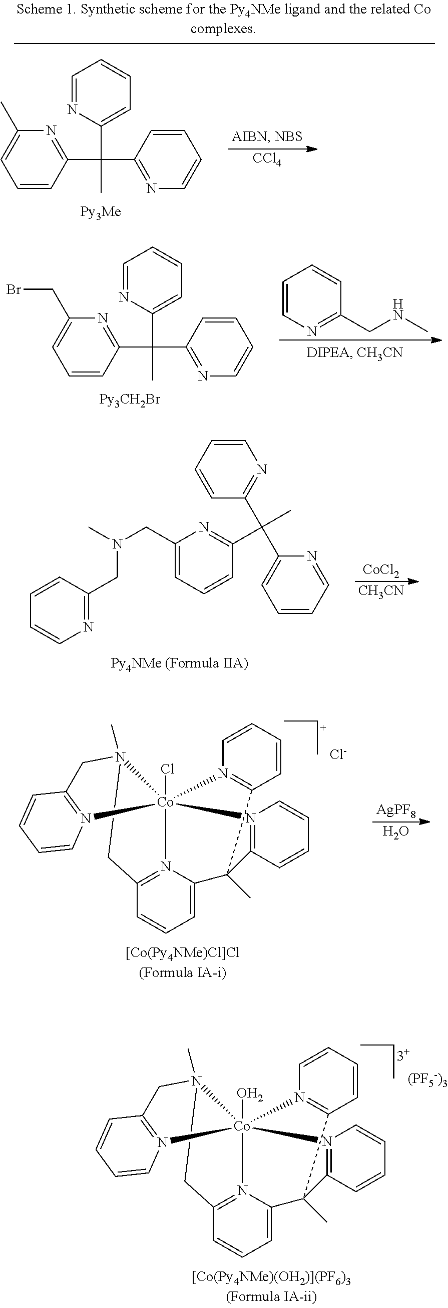

The syntheses of 2,2′-[1-(6-methylpyridin-2-yl)ethane-1,1-diyl]dipyridine (Py₃Me) was carried out according to techniques known in the art.

2,2′-(1-(6-(bromomethyl)pyridin-2-yl)ethane-1,1-diyl)dipyridine (Py₃CH₂Br). N-bromosuccinimide (NBS, 5.7 g, 32 mmol) and 2,2′-azobis(2-methylpropionitrile) (AIBN, 0.49 g, 3 mmol) were added to a solution of 2,2′-[1-(6-methylpyridin-2-yl)ethane-1,1-diyl]dipyridine (Py₃Me, 5.89 g, 21 mmol) in anhydrous CCl₄ (250 mL) at room temperature under Ar protection. The mixture was then heated to reflux for 6 hours and the solvent was removed. The residue was dissolved in dichloromethane and washed with water before dried over anhydrous Na₂SO₄. The crude compound after solvent removal was purified by silica gel column using ethyl acetate/dichloromethane. A white solid (Yield, 2.19 g, 29%) was obtained by stirring the purified compound in hexane overnight. ¹H NMR ((CD₃)₂CO, 400 MHz): δ 2.29 (s, 3H, H-5), 4.57 (s, 2H, H-9), 7.00 (d, Jₒ=7.9 Hz, 1H, H-6), 7.09 (d, Jₒ=8.0 Hz, 2H, H-4), 7.19 (m, Jₒ=6.2 Hz, 2H, H-2), 7.39 (d, Jₒ=7.8 Hz, 1H, H-8), 7.66 (m, 3H, H-3, H-7), 8.50 (d, Jₒ=4.7 Hz, 2H, H-1). ESI-MS: m/z 354.5 (calcd m/z 354.3 for [M+1]+).

1-(6-(1,1-di(pyridin-2-yl)ethyl)pyridin-2-yl)-N-methyl-N-(pyridin-2-ylmethyl)methanamine (Py₄NMe, Formula IIa). To a solution of Py₃CH₂Br (0.5 g, 1.5 mmol) in acetonitrile (20 mL) was added 2-[(methylamino)methyl]pyridine (0.179 g, 0.18 mL, 1.5 mmol) and N,N-diisopropylethylamine (DIPEA, 0.285 g, 0.38 mL, 2.2 mmol) at room temperature and the resulting mixture was stirred overnight. Ethyl acetate was added to extract the compound after brine was added to the solution. The organic layer was dried over anhydrous Na₂SO₄ and the crude compound was purified by basic Al₂O₃ column using ethyl acetate/dichloromethane to afford the product as yellow oil (Yield, 0.443 g, 79%). ¹H NMR ((CDCl₃, 400 MHz): δ 2.25 (s, 3H, H-10), 2.33 (s, 3H, H-5), 3.69 (s, 4H, H-9), 6.93 (d, Jₒ=7.7 Hz, 1H, H-6), 7.04 (d, Jₒ=8.2 Hz, 2H, H-4), 7.08 (m, Jₒ=6.1 Hz, 2H, H-2), 7.12 (m, Jₒ=6.1 Hz, 1H, H-12), 7.30 (d, Jₒ=7.0 Hz, 1H, H-8), 7.41 (d, Jₒ=7.8 Hz, 1H, H-14), 7.53 (m, 3H, H-3, 7), 7.59 (m, Jₒ=7.7 Hz, 1H, H-13), 8.52 (d, Jₒ=4.8 Hz, 1H, H-11), 8.56 (d, Jₒ=4.8 Hz, 2H, H-1). ESI-MS: m/z 396.3 (calcd m/z 396.2 for [M+1]+).

{[Co(Py₄NMe)Cl]Cl}·8H₂O (Formula Ia-i·0.8H₂O). The preparation of Formula Ia-i was followed according to known techniques for producing cobalt complexes [Co(DPA-Bpy)(OH₂)](PF₆)₃ (referred to herein as “Complex C1,” where DPA-Bpy is N,N-bis(2-pyridinyl-methyl)-2,2′-bipyridine-6-methanamine) and [Co(Py₃Me-Bpy)(OH₂)](PF₆)₂ (referred to herein as “Complex C2,” where Py₃Me-Bpy is 6-[6-(1,1-di-pyridin-2-yl-ethyl)-pyridin-2-ylmethyl]-[2,2′]bipyridinyl), but using Py₄NMe as the ligand. A yield of 79% was obtained for this pinkish complex. ESI-MS: m/z 489.3 (calcd m/z 489.1 for [Co(Py₄NMe)Cl]⁺). Anal. Calcd for C₂₅H₂₅N₅CoCl₂·0.8H₂O: C, 55.63; H, 4.97; N, 12.98. Found C, 55.76; H, 5.06; N, 12.78.

{[Co(Py₄NMe)(H₂O)](PF₆)₃}·H₂O (Formula Ia-i·H₂O). A solution of AgPF₆ (700 mg, 2.8 mmol) in 10 mL H₂O was added to an aqueous solution (20 mL) of Formula Ia-i (440 mg, 0.84 mmol) and the resulting reaction mixture was refluxed overnight. Water was removed after filtration of the reaction solution through Celite. The resulting residue was washed with methanol/diethyl ether 3 times. The obtained solid was then redissolved in H₂O for overnight refluxing. A dark red solid (Yield, 471 mg, 62%) was obtained after filtration and water removal. ESI-MS: m/z 618.2 (calcd m/z 618.4 for {[Co(Py₄NMe)(F)](PF₆)}⁺. Anal. Calcd for C₂₅H₂₇N₅CoP₃F₁₈O·H₂O: C, 32.45; H, 3.16; N, 7.57. Found C, 32.31; H, 2.91; N, 7.53.

Alternatively, Formula Ia-ii can be prepared from the reaction of the Py₄NMe ligand with [Co(CH₃CN)₆](PF₆)₂ in acetone/H₂O to afford complex [Co(Py₄NMe)(OH₂)](PF₆)₂·H₂O, which can be converted to Formula Ia-ii by refluxing with AgPF₆ in water.

[Co(Py₄NMe)(OH₂)](PF₆)₂·2H₂O. [Co(CH₃CN)₆](PF₆)₂ (0.797 g, 1.5 mmol) in 60 mL acetone was slowly added to a refluxing solution of Py₄NMe (0.541 g, 1.4 mmol) in 30 mL acetone and the resulting solution was continued to reflux overnight. Acetone solvent was removed after filtration over celite and the solid was washed with acetone/ether 4 times. Degassed Millipore water (˜100 mL) was then added to the dried solid and refluxed overnight. Another filtration was performed, and water was removed to afford a dark red solid (Yield, 0.549 g, 52.7%). Anal. Calcd for C₂₅H₃₁CoF₁₂N₅O₃P₂: C, 37.61; H, 3.91; N, 8.77. Found C, 37.81; H, 3.76; N, 8.37.

[Co(Py₄NMe)(OH₂)](PF₆)₃ (Formula Ia-ii). A solution of AgPF₆ (134.4 mg, 0.53 mmol) in 10 mL Millipore H₂O was added to an aqueous solution (50 mL) of [Co(Py₄NMe)(OH₂)](PF₆)₂·2H₂O (400.2 mg, 0.53 mmol) and the resulting reaction mixture was refluxed overnight. Water was removed after the reaction solution was filtered through Celite. The resulting residue was washed with methanol/diethyl ether 3 times. The obtained solid was then redissolved in Millipore H₂O and refluxed overnight at 103° C. A red solid (Yield, 279 mg, 58.5%) was obtained after cold filtration and water removal. Anal. Calcd for C₂₅H₂₇CoF₁₈N₅OP₃: C, 33.09; H, 3.00; N, 7.72. Found C, 33.32; H, 3.18; N, 7.53.

### Example 3: Analysis and Discussion

The efficiency of electro- and photocatalytic HER is well-known to be strongly pH-dependent. While electro- and/or photocatalytic hydrogen production under basic solutions have been reported for heterogeneous catalysts, only a limited number of molecular metal complexes are known for HER under basic conditions. The reported photocatalytic HER catalyzed by molecular catalysts under basic conditions are generally conducted in a mixture of organic solvents and aqueous solutions. However, the highly oxidizing conditions needed for water oxidation suggest that organic solvents should be avoided in solar-driven water splitting devices. As best understood, visible-light driven HER catalyzed by molecular metal complexes in purely aqueous solutions at basic pHs has not been reported. Therefore, it remains a significant challenge in developing molecular transition metal complexes that can catalyze photolytic HER in basic aqueous solutions in the absence of any organic solvent.

Molecular cobalt complexes with polypyridyl ligands for photocatalytic/electrocatalytic hydrogen production in aqueous solutions have been reported. Studies have shown that the optimal pHs for photocatalytic HER by cobalt complexes depend on the electronic and structural properties of ligand scaffolds. Analyzed herein with the complexes of Formula Ia-i and Formula Ia-ii are two comparative complexes, Complex C1 and Complex C2, shown below. Complex C1 displays maximum HER activity at pH 4 using ascorbic acid as electron donor and [Ru(Bpy)₃]²⁺ as photosensitizer. Complex C2 displays the highest activity for photocatalytic HER at pH 7 aqueous solutions with much improved activity and stability compared to Complex C1. The complexes of Formula Ia-i and Formula Ia-ii display remarkable activity for photocatalytic HER with exceptional stability and TON of 218, 000 in a pH 9 aqueous solution, which further elucidate the electronic and structural factors that govern the pH-dependent photocatalytic HER.

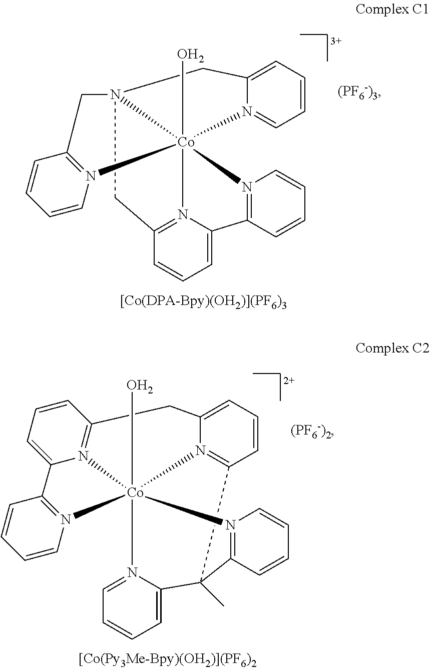

The crystal structure of the cation of Formula Ia-i was observed as a distorted octahedral geometry with an axial chloride ligand. Vapor diffusion of benzene into a methanol solution of Formula Ia-ii yields crystals whose X-ray structure shows the binding of a fluoride ion to the Co^{III} center due to the decomposition of PF₆⁻ anion, consistent with the ESI/MS data obtained for Formula Ia-ii. Furthermore, the axial chloride ligand observed for the cation of Formula Ia-i and the fluoride ligand of the cation of Formula Ia-ii following the vapor diffusion lie trans and cis, respectively, to the pyridyl linked to the —CH₂N(Me)CH₂Py moiety. The UV-vis spectrum of Formula Ia-ii in water shows a broad peak at 488 nm from the d-d transition of the Co^{III}—OH2 form, similar to that of Complex C1, while no significant absorption was observed for the complex of Formula Ia-i in acetonitrile from 300 nm to 800 nm.

Cyclic voltammograms (CV) of the complex of Formula Ia-i, and Formula Ia-i in the presence of ferrocene, in 0.1 M Bu₄NPF₆/CH₃CN solution were conducted using a scan rate of 100 mV/s, a glassy carbon working electrode, an Ag/AgCl reference electrode, a Pt wire counter electrode, and ferrocene as internal reference. The CV of Formula Ia-i in CH₃CN displays three quasi-reversible redox events at −0.10, −1.72, and −2.29 V (vs Fc⁺/Fc), corresponding to Co^{III}/Co^{II}, Co^{II}/Co^{I}, and Co^{I}/Co⁰ (or ligand-based) redox couples, respectively. The Co^{II}/Co^{I} couple at −1.72 V (vs Fc⁺/Fc) for the complex of Formula Ia-i is more negative than those of the Co^{II}—Cl forms of Complex C1 (−1.58 V vs Fc⁺/Fc) and Complex C2 (−1.54 V vs Fc⁺/Fc) due to the substitution of the Bpy group in Complex C1 and Complex C2 with more basic amine moiety.

In 1 M potassium phosphate solution at pH 7.0, the CV of Formula Ia-ii displays a quasi-reversible redox event at 0.20 V (vs SHE) which is assignable to the Co^{III}/Co^{II} couple. The Pourbaix diagram of the Co^{III}/Co^{II} couple of Formula Ia-ii in universal buffer shows a pH dependent redox potential change from pH 3.5 to pH 11.5 with a slope of 58.5 mV/pH, suggesting a PCET process. Based on the Pourbaix diagram, the pKa's of Co^{III}—OH₂ and Co^{II}—OH₂ for Formula Ia-ii were derived as 3.5 and 11.5, respectively. At more negative potentials, the CV of Formula Ia-ii in 1 M phosphate buffer at pH 7.0 shows one irreversible reduction event at −1.12 V (vs SHE) before catalysis (CV conducted using 1 mM of Formula Ia-ii in 1 M pH 7.0 sodium phosphate buffer, scan rate, 100 mV s⁻¹; Hg pool working electrode, Ag/AgCl reference electrode, Pt mesh counter electrode). Compared to Complexes C1 and C2, the redox potential of −1.12 V for the Co^{II}/Co^{I} couple of 3b is much more negative than those of Complex C1 (−0.84 V) and Complex C2 (−0.70 V vs SHE).

Due to the higher stability of the complex Formula Ia-ii in air and its one-electron reduction leads to the formation of the complex of Formula Ia-i, only Formula Ia-ii was used for the HER catalysis study. The photocatalytic HER activity of Formula Ia-ii was investigated in a similar way as reported for Complexes C1 and C2 using 50 nM of Formula Ia-i, 0.1 M ascorbic acid as electron donor and 0.5 mM [Ru(Bpy)₃]²⁺ as photosensitizer in 0.5 M Britton-Robinson buffer. At pH 7, Formula Ia-ii (50 nM) catalyzed HER with a TON of 22,400, significantly higher than those reported for Complexes C1 and C2 at pH 7 solutions. Surprisingly, a pH screening of the photocatalytic HER by Formula Ia-ii demonstrated that Formula Ia-ii is more active at basic aqueous solutions. At pH 9, Formula Ia-ii displays the highest activity with a TON of 218,000 after ˜40 hour photolysis with a TOF of 12500/hour during the first 5-h photolysis. Under the same conditions, the Complexes C1, C2 and CoSO₄ produced negligible amounts of H₂ close to that of control experiment in the absence of Formula Ia-ii. Therefore, Formula Ia-ii is the most active catalyst for photocatalytic HER in alkaline solutions among the Complexes C1, C2 and the complex of Formula Ia-ii. Mercury poison test also confirmed the molecular nature of the complex of Formula Ia-ii during photocatalytic HER at pH 9.0. At 1.0 and 10 μM of Formula Ia-ii, the amount of H₂ produced was 0.628 mmol with TON of 62800 and 0.757 mmol with TON of 7570, respectively, demonstrating Formula Ia-ii is truly effective for photocatalytic HER in basic solutions.

As shown in Table 1, photocatalytic HER in alkaline solutions have been reported for metal complexes in systems containing different photosensitizers and sacrificial electron donors at various pHs with TONs ranging from ˜10 to 11333 in mixed organic aqueous solutions. The complex of Formula Ia-ii is demonstrated as a rare example for photocatalytic HER in alkaline aqueous solutions without using any organic solvents with a remarkable TON of 218000 at pH 9.0. While a direct comparison of the complex of Formula Ia-ii to the reported catalysts is not practical due to the different photocatalysis conditions reported in literature, the TON and TOF of the complex of Formula Ia-ii are certainly among the highest reported for homogeneous photocatalytic HER in alkaline aqueous solutions.

TABLE 1
Photocatalytic hydrogen production in alkaline solutions by transition metal complexes.

| | | Sacrificial | Light | | | | |
|---|---|---|---|---|---|---|---|
| Catalyst | Photo-sensitizer | agents | source | pH | Solvents | TON | TOF |
| [Co(Py4NMe)(OH2)](PF6)3 | [Ru(Bpy)3]Cl2 | Ascorbate | LED | 9 | Universal | 218000 | 12500/h |
| Formula Ia-ii | | | 450 | | buffer | | |
| | | | nm | | | | |
| [Ni(Hqt)2(4,4′-H-2,2′-Bpy) | Fluorescein | Triethylamine | λ > | 12.3 | EtOH/H2O | 5923 | N/A |
| | | | 420 | | | | |
| | | | nm | | | | |
| [Ni(Hqt)2(4,4′-Me-2,2′-Bpy) | Fluorescein | Triethylamine | λ > | 12.3 | EtOH/H2O | 7634 | N/A |
| | | | 420 | | | | |
| | | | nm | | | | |
| [(bpy)2RuIINiII(L1)](ClO4)2 | N/A | Triethylamine | 480 | 11 | MeCN/H2O | 49 | N/A |
| | | | nm | | | | |
| [Ni(4,4′-dmpy)(2-pySe)2] | Florescein | Triethylamine | λ > | 11.07 | MeCN/H2O | 1340 | N/A |
| | | | 480 | | | | |
| | | | nm | | | | |
| [Co(L)](BF4)2 | [Ir(ppy)2(bpy)](PF6) | Triethylamine | λ > | 10 | MeCN/H2O | 34 | 8280/h |
| | | | 400 | | | | |
| | | | nm | | | | |
| Co(Dmphen-DPA)(H2O)](ClO4)2 | [Ir(ppy)2(bpy)](PF6) | Triethylamine | λ > | 10 | MeCN/H2O | 210 | N/A |
| | | | 400 | | | | |
| | | | nm | | | | |
| Ni(Dmphen-DPA)(H2O)](ClO4)2 | [Ir(ppy)2(bpy)](PF6) | Triethylamine | λ > | 10 | MeCN/H2O | 11 | N/A |
| | | | 400 | | | | |
| | | | nm | | | | |
| [Co(PyMepam)](BF4)2 | [Ir(ppy)2(bpy)](PF6) | Triethylamine | λ > | 10 | MeCN/H2O | 290 | N/A |
| | | | 400 | | | | |
| | | | nm | | | | |
| [Co(dmgH)2pyCl] | Pt(II)terpyridylphenyl- | Triethanola- | λ > | 8.5 | MeCN/H2O | 1000 | N/A |
| | acetylide | mine | 410 | | | | |
| | | | nm | | | | |
| [Co(dmgH)2pyCl] | Pt(II)terpyridylphenyl- | Triethanola- | λ > | 8.5 | MeCN/H2O | 2150 | N/A |
| | acetylide | mine | 410 | | | | |
| | | | nm | | | | |
| NiTSC-OMe | [Ir(ppy)2(bpy)](PF6) | Triethylamine | White | 10 | MeCN/H2O | 11333 | 7971/h |
| | | | LED | | | | |
| | | | lamp | | | | |
| [Co(DO)(DOH)pnBr2] | [Ir(ppy)2(bpy)](PF6) | Triethylamine | λ > | 10 | MeCN/H2O | 700 | N/A |
| | | | 400 | | | | |
| | | | nm | | | | |
| [{(μ- | [Ir(ppy)2(bpy)](PF6) | Triethylamine | λ > | 11 | Acetone/H2O | 132 | N/A |
| SCH2)2NCH2C6H5}{Fe(CO)3}{Fe(CO)2P(Pyr)3}] | | | 400 | | | | |
| | | | nm | | | | |
| CoII-salen | Eosin Y | Triethylamine | 450 | 10 | MeOH/H2O | 319 | N/A |
| complexes | | | nm | | | | |
| NiII-salen | Eosin Y | Triethylamine | 450 | 10 | MeOH/H2O | 362 | N/A |
| complexes | | | nm | | | | |
| [Co(DO)(DOH)pnBr2] | [Cu(Xantphos)(Bathocu- | Triethylamine | 405 | 10 | MeCN/H2O | 1176 | N/A |
| | proine)](PF6) | | nm | | | | |

In conclusion, the results demonstrate visible light-driven hydrogen production catalyzed by a molecular Co complex in alkaline aqueous solutions that may be important for coupling to the oxidation of water for overall water splitting in alkaline solutions. Also demonstrated herein is the extraordinary performance of the complexes of Formula Ia-i and Formula Ia-ii, in terms of both TON and TOF, for photocatalytic HER especially at basic pHs.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the present disclosure, additionally, they do not exclude impurities and variances normally associated with the elements and materials used.

Numerical ranges used herein include the numbers recited in the range. For example, the numerical range “from 1 wt % to 10 wt %” comprises 1 wt % and 10 wt % within the recited range.

For the sake of brevity, only some ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range comprises every point or individual value between its end points even though not explicitly recited. Thus, every point or individual value may serve as its own lower or upper limit combined with any other point or individual value or any other lower or upper limit, to recite a range not explicitly recited.

All numerical values within the detailed description herein are modified by “about” the indicated value, and take into account experimental error and variations that would be expected by a person having ordinary skill in the art.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, references to “one embodiment” or “an embodiment” of the present disclosure are not intended to be interpreted as excluding the existence of additional embodiments that also incorporate the recited features. The terms of “upstream” and “downstream” are understood relatively to the normal direction of circulation of a fluid in a conduit.

All documents described herein are incorporated by reference herein, including any priority documents and or testing procedures to the extent they are not inconsistent with this text. As is apparent from the foregoing general description and the specific embodiments, while forms of the present disclosure have been described, various modifications can be made without departing from the spirit and scope of the present disclosure. Accordingly, it is not intended that the present disclosure be limited thereby.

As used herein, the term “comprising” is considered synonymous with the term “including” for purposes of United States law. Whenever a composition, an element or a group of elements is preceded with the transitional phrase “comprising,” it is understood that the transitional phrases “consisting essentially of,” “consisting of,” “selected from the group of consisting of,” or “is” can additionally or alternatively precede the recitation of the composition, element, or elements and vice versa.

The specific embodiments described herein have been provided by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for (perform)ing (a function) . . . ” or “step for (perform)ing (a function) . . . ”, it is intended that such elements are to be interpreted under 35 U.S.C. 112(f). However, for any claims containing elements designated in any other manner, it is intended that such elements are not to be interpreted under 35 U.S.C. 112(f).

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A catalyst for producing hydrogen via the hydrogen evolution reaction during water splitting, wherein the catalyst is a metal complex of Formula I,
[M(L¹)(L²)][A] Formula I
wherein M is a transition metal, L¹ and L² are both ligands independently forming one or more coordinate bonds with the metal M, and A is an anion, and
wherein L¹ is a tetrapyridyl-amine (Py₄N) having four pyridyl groups and an amine group each forming a coordinate bond with the metal M.

2. The catalyst of claim 1, wherein the amine group of Py₄N is a tertiary amine group.

3. The catalyst of claim 1, wherein the tetrapyridyl-amine (Py₄N) has a Formula II, 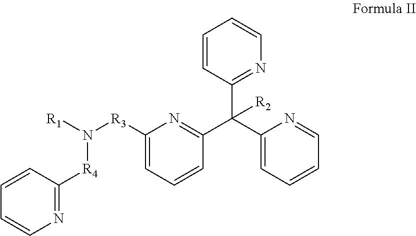
wherein R¹ and R² are each independently selected from the group consisting of hydrogen, alkyl, aryl, alkoxyl, and aryloxyl;
and R³ and R⁴ are each independently selected from the group consisting of alkyl, aryl, alkoxyl, and aryloxyl.

4. The catalyst of claim 3, wherein R¹, R², R³, and R⁴ are each independently selected from the group consisting of C₁-C₆ alkyl.

5. The catalyst of claim 3, wherein R¹, R², R³, and R⁴ are each a C₁ alkyl and the ligand L¹ is of Formula IIa,

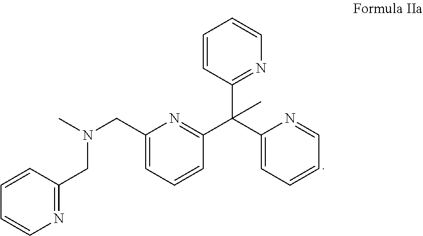 [SMILES: CN(Cc1ccccn1)Cc1cccc(C(C)(c2ccccn2)c2ccccn2)n1]

6. The catalyst of claim 1, being a metal complex of Formula Ia, 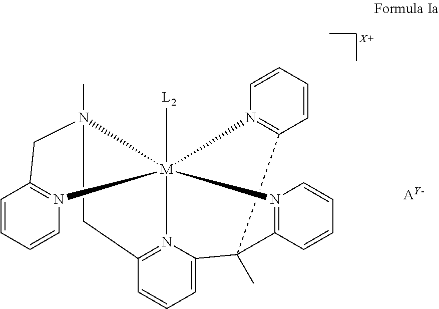
wherein X and Y are the same integer.

7. The catalyst of claim 6, wherein X and Y are the same integer between 1 to 3.

8. The catalyst of claim 6, wherein the metal M is cobalt.

9. The catalyst of claim 8, wherein the catalyst is a cobalt complex of Formula Ia-i,

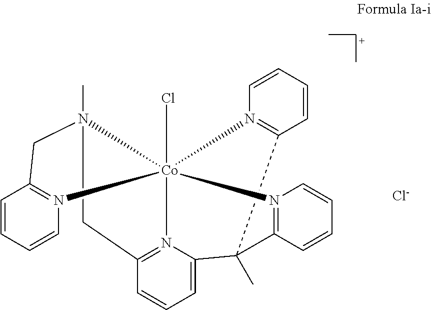

10. The catalyst of claim 8, wherein the catalyst is a cobalt complex of Formula Ia-ii,

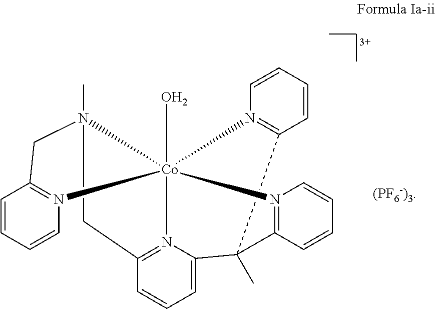

11. A method of producing hydrogen via photocatalytic water splitting, the method comprising contacting an aqueous composition with the catalyst of claim 1, wherein the catalyst has photolytic hydrogen evolution reaction activity in the aqueous composition to drive the hydrogen evolution reaction in response to light exposure.

12. The method of claim 11, wherein the aqueous composition is configured such that the oxygen evolution reaction in the aqueous composition is thermodynamically favored in response to the light exposure over the hydrogen evolution reaction in the absence of the catalyst in the aqueous composition.

13. The method of claim 12, wherein the aqueous composition is an aqueous alkaline composition having a pH of greater than 8.

14. The method of claim 11, wherein the aqueous composition is an aqueous alkaline composition comprising the water as a primary solvent.

15. The method of claim 14, wherein the aqueous alkaline composition is substantially free of organic solvents and/or non-aqueous solvents.

16. The method of claim 11, further comprising exposing the catalyst to light via a light source to drive the hydrogen evolution reaction.

17. The method of claim 16, wherein the light source comprises sunlight, one or more UV lamps, one or more Xenon lamps, or a combination thereof.

18. A composition for use in photocatalytic water splitting, the composition comprising:
water; and
the catalyst of claim 1.

19. The composition of claim 18, wherein the composition is configured such that the oxygen evolution reaction in the composition is thermodynamically favored in response to light exposure over the hydrogen evolution reaction in the absence of the catalyst in the composition.

20. The composition of claim 18, wherein the composition is an aqueous alkaline composition comprising the water as a primary solvent, wherein the aqueous alkaline composition is substantially free of organic solvents and/or non-aqueous solvents.
